(19) United States
(12) Patent Application Publication
(10) Pub. No.: US 2022/0222241 A1
(43) Pub. Date: Jul. 14, 2022

(54) AUTOMATED DISTRIBUTED VERACITY EVALUATION AND VERIFICATION SYSTEM

(71) Applicant: Daniel L. Coffing, Fairfax, VA (US)

(72) Inventor: Daniel L. Coffing, Fairfax, VA (US)

(21) Appl. No.: 17/575,381

(22) Filed: Jan. 13, 2022

Related U.S. Application Data
(60) Provisional application No. 63/136,965, filed on Jan. 13, 2021.

(51) Int. Cl. G06F 16/23; G06F 21/64

(52) U.S. Cl. CPC G06F 16/2365; G06F 21/64

(57) ABSTRACT

Systems and methods for verifying and/or challenging the veracity and/or objectivity of media content are provided. In some examples, a warranty system stores, in a distributed ledger, a warranty of veracity of an aspect of a media asset. The warranty includes a smart contract specifying that an action is to be performed in response to a condition being met. The warranty system receives a challenge from a challenger device. The challenge disputes the veracity of the aspect of the media asset. The warranty system verifies that the challenge accurately disputes the veracity of the aspect of the media asset. The warranty system identifies that the condition is met based on verification that the challenge accurately challenges the veracity of the aspect of the media asset. The warranty system automatically triggers performance of the action in response to identifying that the condition is met.

### CROSS-REFERENCE TO RELATED APPLICATIONS

The present application claims the priority benefit of U.S. provisional application 63/136,965 filed Jan. 13, 2021 and entitled “Automated Distributed Veracity Evaluation and Verification System,” the disclosure of which is incorporated herein by reference.

### BACKGROUND OF THE INVENTION

### 1. Field of the Invention

The present invention relates to media verification and distributed computing. In particular, the present invention relates to providing enforceable warranties as to veracity of media content using smart contracts that are stored in and executed through a distributed ledger.

### 2. Description of the Related Art

In news reporting, there are often multiple layers between raw information and readers or audiences. For instance, journalists or other content producers may produce an article or other piece of content about the information, publishers may further edit the article, secondary content producers and secondary publishers may produce and publish secondary articles based on the initial article, and so forth. Each of these layers, through human error or intentional manipulation, may introduce distortions, embellishments, inaccuracies, cognitive biases, or opinions into the raw information. By the time the information is received by readers or audiences, the raw information may have been substantially biased, distorted, and/or rendered inaccurate. Even if a content producer or publisher later issues a retraction, readers or audiences who relied on the information as it was previously presented have no recourse for errors they have made by relying on that information, and may even lack knowledge of the retraction altogether.

Fact checking refers to is a process that seeks to verify factual information and challenge incorrect information in order to make readers and audiences aware of the truth of a matter. Ante-hoc fact checking refers to fact checking before publication or dissemination of information, while post-hoc fact checking refers to fact checking after information is published. Traditional media publication processes provide little incentive for thorough ante-hoc fact checking, instead often incentivizing overly sensational headlines through increased views of advertisements presented alongside the information. Traditional media publication processes provide little to no incentive or visibility for thorough post-hoc fact checking, as readers or audiences rarely return to a subject they have already consumed media about it.

Thus, there is a need for improved media publication, reviewing, and correction technologies.

### SUMMARY OF THE CLAIMS

A system and method are provided for verifying and/or challenging the veracity of media content.

According to one example, a method of automated media content challenge verification and enforcement is provided. The method includes storing, in a distributed ledger, a warranty of veracity of an aspect of a media asset. The warranty includes a smart contract specifying that an action is to be performed in response to a condition being met. The method includes receiving a challenge from a challenger device. The challenge disputes the veracity of the aspect of the media asset. The method includes verifying that the challenge accurately disputes the veracity of the aspect of the media asset. The method includes identifying that the condition is met based on verification that the challenge accurately challenges the veracity of the aspect of the media asset. The method includes automatically triggering performance of the action in response to identifying that the condition is met.

### BRIEF DESCRIPTION OF THE DRAWINGS

FIG. 1 is a block diagram illustrating an architecture of an example warranty system.

FIG. 2A is a conceptual diagram illustrating an information flow pipeline along which information flows from an information source to an audience.

FIG. 2B is a conceptual diagram illustrating a challenger issuing a challenge to the veracity of published media along the information flow pipeline.

FIG. 2C is a conceptual diagram illustrating the challenge from the challenger of FIG. 2B triggering compensation that flows downstream along the information flow pipeline for those who relied on the published media.

FIG. 3 is a block diagram illustrating a distributed ledger configured to store smart contracts and provide for execution of the smart contracts.

FIG. 4 is a conceptual diagram illustrating a distributed computing architecture for initiating a smart contract using a distributed ledger.

FIG. 5 is a conceptual diagram illustrating a distributed computing architecture for initiating a smart contract using a distributed ledger.

FIG. 6 is a conceptual diagram illustrating a directed acyclic graph (DAG) ledger configured to store smart contracts and provide for execution of the smart contracts.

FIG. 7A is a flow diagram illustrating example operations for automated media content challenge verification and enforcement.

FIG. 7B is a flow diagram illustrating example operations for automated media veracity challenge verification and enforcement.

FIG. 8 is a system diagram of an exemplary computing system that may implement various systems and methods discussed herein, in accordance with various embodiments of the subject technology.

### DETAILED DESCRIPTION

Embodiments of the present invention may include systems and methods for verifying and/or challenging the veracity of media content. In particular, systems and methods may be provided for providing enforceable warranties as to veracity of media content. A media entity along an information flow pipeline, such as a journalist or a publisher, may generate media content based on raw information from an information source. The media content may include written content, such as an article, blog post, or social media network post. The media content may include one or more images. The media content may include one or more videos, such as television segments aired during a television program on a television channel (e.g., a news television program, a political commentator television program). The media content may include one or more audio recording, such as radio segments aired during a radio program on a radio channel (e.g., a talk show program) or podcast segments aired during a podcast episode on a podcast. An element of media content, such as an article, a television segment, or a radio segment, may be referred to as a media asset.

A media warranty system may allow the media entity to provide a warranty as to the veracity of at least an aspect of a media asset. For example, the media warranty system may allow the media entity to provide a warranty as to the veracity of certain assertions that the media entity has made in a media asset. The warranty may be stored and implemented using one or more smart contracts. Each of the smart contracts may be stored in and/or executed through a distributed ledger, such as a blockchain ledger or a directed acyclic graph (DAG) ledger. A smart contract in a warranty as to the veracity of an aspect of a media asset may identify a condition and an action. The condition may, for example, be that a situation occurs in which the aspect of a media asset is determined to be inaccurate. The action may include, for instance, triggering compensation to be disbursed from an account associated with the media entity to an account of a challenger who has successfully fact-checked the media asset. The action may include triggering compensation to be disbursed from an account associated with the media entity to an account of one or more users who have accessed and/or relied on the aspect of the media asset. The media entity may back the warranty as to the veracity of the aspect of the media asset with a source of compensation for inaccuracies in the media asset if inaccuracies in the media asset are found. For instance, the source of compensation may be a portion of advertising revenue earned through the media asset.

A challenger, such as an independent fact checker, may review the media asset and may issue a challenge that disputes the veracity of at least an aspect of the media asset. For instance, the challenge may dispute the veracity of a particular assertion made in an article published by a news entity. The challenger's challenge may itself be analyzed and/or verified, for instance by the warranty system itself, by a distributed computing architecture and/or community associated with the distributed ledger, or a combination thereof.

The warranty system may verify that the challenge accurately disputes the veracity of the aspect of the media asset. In an illustrative example, the media asset may include an assertion that a particular statement was made by a particular speaker. A challenge to the veracity of the article may dispute the text of the statement provided in the article, for instance by providing alternate text of the statement. The warranty system may verify that the challenge is accurate, for instance by verifying that the text of the statement provided in the article is inaccurate, by verifying that the alternate text of the statement provided in the challenge is accurate, or both. Based on the verification that the challenge is accurate, the warranty system identifies that the condition in the smart contract of the warranty is met. The warranty system can automatically triggers performance of the action in response to identifying that the condition in the smart contract of the warranty is met.

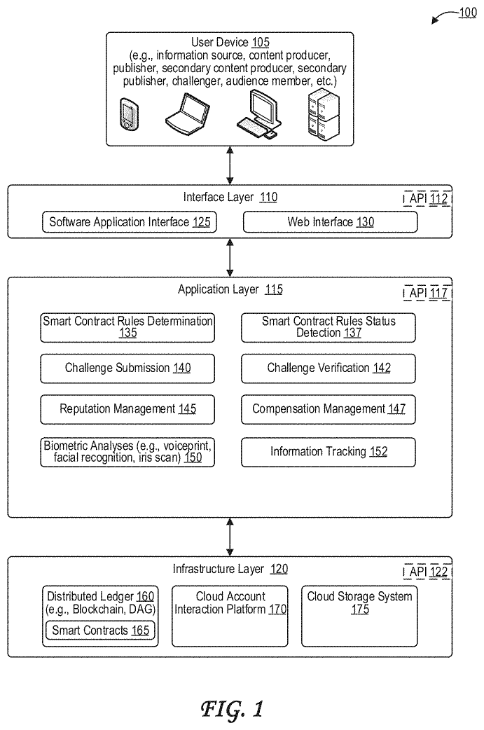

FIG. 1 is a block diagram illustrating an architecture of an example warranty system 100. The architecture of the warranty system 100 includes three layers—an interface layer 110, an application layer 115, and an infrastructure layer 120. The interface layer 110 generates and/or provides one or more interfaces that user devices 105 interact with. The interface layer 110 can receive one or more inputs from user devices 105 through the one or more interfaces. The interface layer 110 can receive content from the application layer 115 and/or the infrastructure layer 120 and display the content to the user device 105 through the one or more interfaces.

The one or more interfaces can include graphical user interfaces (GUIs) and other user interfaces (UIs) that the user device 105 directly interacts with. The one or more interfaces can include interfaces directly with software running on the user device 105, for example interfaces that interface with an application programming interface (API) of software running on the user device 105. The one or more interfaces can include interfaces with software running on an intermediary device between the warranty system 100 and the user device 105, for example interfaces that interface with an application programming interface (API) of software running on the intermediary device. The intermediary device may be, for example, a web server (not pictured) that hosts and/or serves a website to the user device 105, where the web server provides inputs that the web server receives from the user device 105 to the warranty system 100.

The one or more interfaces generated and/or managed by the interface layer 110 may include a software application interface 125 and a web interface 130. The software application interface 125 may include interfaces for one or more software applications that run on the user device 105. For instance, the software application interface 125 may include an interface that calls an API of (or otherwise interacts with) a software application that runs on (or that is configured to run on) on the user device 105. In some cases, the software application may be a mobile app, for instance where the user device 105 is a mobile device. The software application interface 125 may include interfaces for one or more software applications that run on an intermediate device between the user device 105 and the warranty system 100. For instance, the software application interface 125 may include an interface that calls an API of (or otherwise interacts with) a software application that runs on (or that is configured to run on) on the intermediate device.

The web interface 130 can include a website. The web interface 130 may include one or more forms, buttons, or other interactive elements accessible by the user device 105 through the website. The web interface 130 may include an interface to a web server, where the web server actually hosts and serves the website, and provides inputs that the web server receives from the user device 105 to the warranty system 100. For instance, the web interface 130 may include an interface that calls an API of (or otherwise interacts with) the web server. The web server may be remote from the warranty system 100.

In some examples, the interface layer 110 may include an API 112 that can trigger performance of an operation by the interface layer 110 in response to being called by the application layer 115, the infrastructure layer 120, the user device 105, the above-described web server, another computing system 700 that is remote from the warranty system 100, or another device or system described herein. Any of the operations described herein as performed by the interface layer 110 may be performed in response to a call of the API 112 by one of the devices or systems listed above.

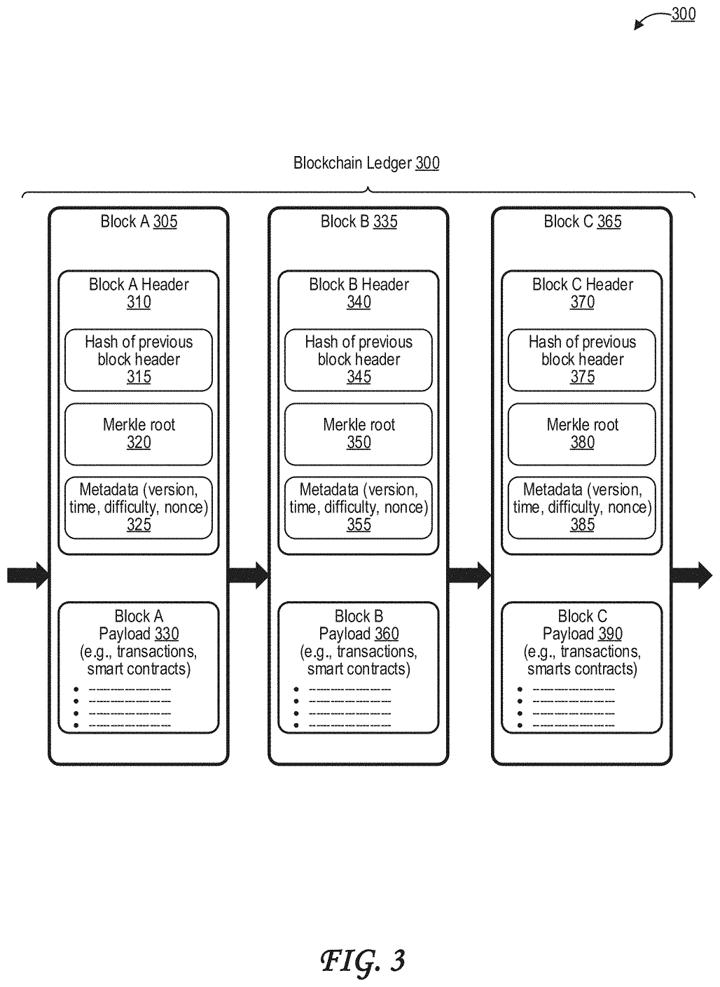

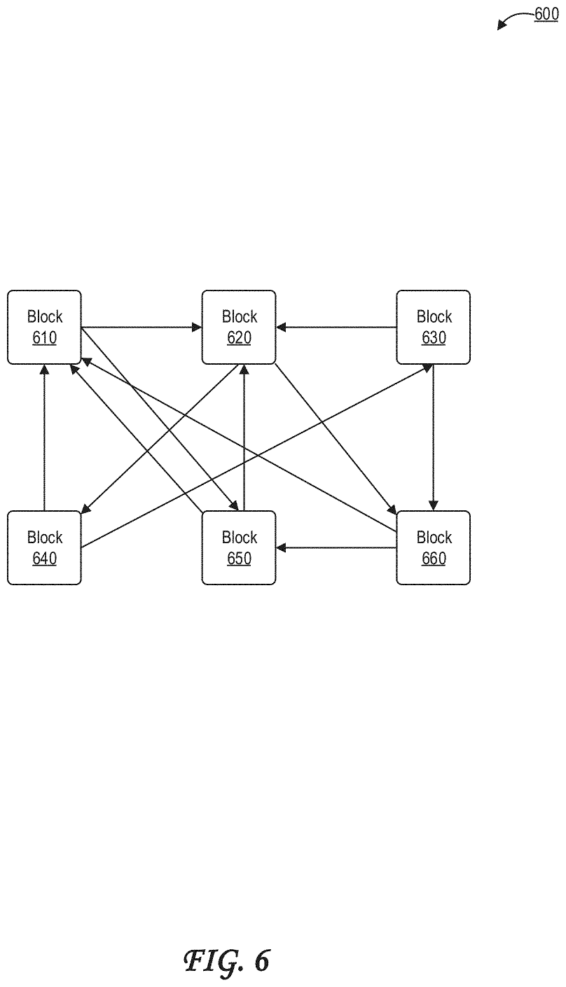

The infrastructure layer 120 includes a distributed ledger 160 that stores one or more smart contracts 165. The distributed ledger 160 may be decentralized, stored, and synchronized among a set of multiple devices. The distributed ledger 160 may be public or private. In some examples, the distributed ledger 160 may be a blockchain ledger such as the blockchain ledger illustrated in FIG. 3. For instance, the blockchain ledger may be an Ethereum blockchain ledger. In some examples, the distributed ledger 160 may be a directed acyclic graph (DAG) ledger such as the DAG ledger illustrated in FIG. 6.

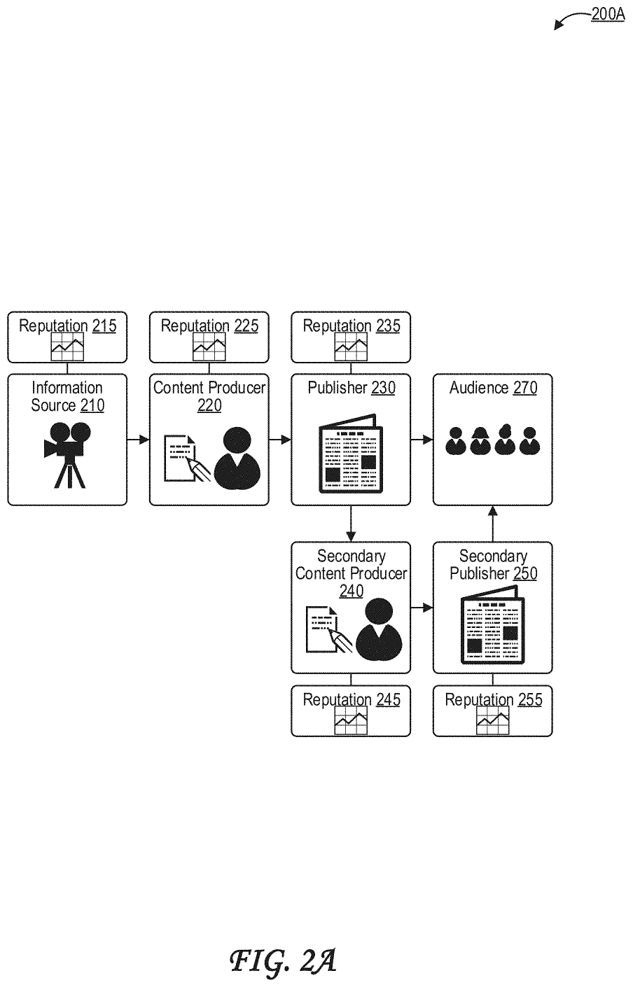

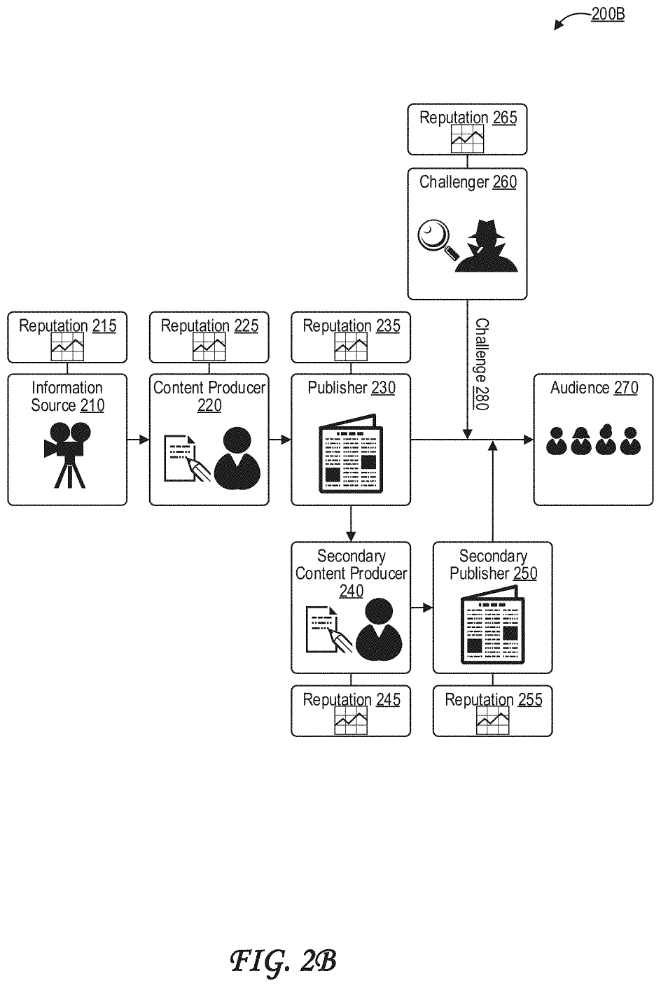

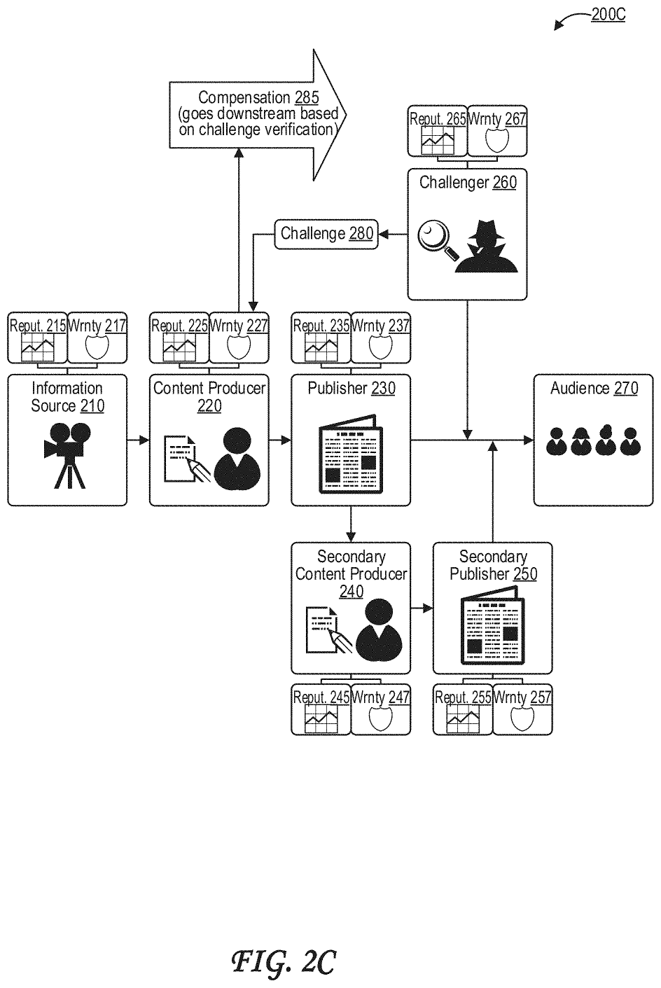

The interface layer 120 can include a cloud account interaction platform 170. The cloud account interaction platform 170 may allow different users, such as users associated with user devices 105, to create and manage user accounts. The cloud account interaction platform 170 can allow one user using one user account to communicate with another user using another user account, for example by sending a message or initiating a call between the two users through the cloud account interaction platform 170. The user accounts may be tied to financial accounts, such as bank accounts, credit accounts, gift card accounts, store credit accounts, and the like. The cloud account interaction platform 170 can allow one user using one user account to transfer funds or other assets (e.g., the compensation 285 of FIG. 2C) from a financial account associated with their user account to or from another financial account associated with another user using another user account, for instance in response to verification that the challenge 280 successfully challenges the veracity of a media asset. In some examples, the cloud account interaction platform 170 processes the transfer of funds by sending a fund transfer message to a financial processing system that performs the actual transfer of funds between the two financial accounts. The fund transfer message can, for example, identify the two financial accounts and an amount to be transferred between the two financial accounts.

The interface layer 120 can include a cloud storage system 175. The cloud storage system 175 can store information associated with a user account of a user associated with a user device 105. In some examples, the cloud storage system 175 can store a copy of a media asset, such as an article, an image, a television segment, a radio segment, or a combination thereof. In some examples, the cloud storage system 175 can store a copy of a challenge to the veracity of at least an aspect of the media asset, such as the challenge 280 of FIGS. 2B-2C. In some examples, the storage system 175 can store a smart contract of the smart contracts 165, while the distributed ledger 160 stores a hash of the smart contract instead of (or in addition to) storing the entire smart contract.

In some examples, the infrastructure layer 120 may include an API 122 that can trigger performance of an operation by the infrastructure layer 120 in response to being called by the interface layer 110, the application layer 115, the user device 105, the above-described web server (not pictured), another computing system 700 that is remote from the warranty system 100, or another device or system described herein. Any of the operations described herein as performed by the infrastructure layer 120 may be performed in response to a call of the API 122 by one of the devices or systems listed above.

The application layer 115 may include a smart contract rules determination engine 135, through which rules of the smart contracts 165 may be determined. The smart contract rules determination engine 135 may identify for example, a condition and an action associated with a media asset, or an aspect of a media asset. In some examples, the smart contract rules determination engine 135 may identify the condition to be identification that the veracity of the media asset (or the aspect of the media asset) is shown to be inaccurate by a successful challenge to the veracity of the media asset (or the aspect of the media asset). A successful challenge may be a challenge whose own veracity is determined to be accurate by the warranty system 100.

The application layer 115 may include a smart contract rules status detection engine 137, through which the status of a rule in a smart contract is monitored periodically. The smart contract rules status detection engine 137 may monitor for the existence of a challenge to the warranty and/or to the veracity of the media asset associated with the warranty (or aspect thereof). This monitoring may be achieved by identifying when a challenge submission matching (e.g., identifying an identifier corresponding to) the warranty and/or the media asset associated with the warranty (or aspect thereof) is received through the challenge submission engine 140. Once such a challenge is detected, the smart contract rules status detection engine 137 may monitor for the verification as to the veracity of the challenge to an extent that meets the condition in the smart contract. In some examples, this may be performed based on successful challenge verification by the challenge verification engine 142.

The challenge submission engine 140 is a portal through which a user device 105 associated with a challenger (a challenger device) can submit a challenge. The challenge may identify the media asset (or aspect thereof) that the challenge disputes the veracity of, for instance using an identifier code or number that identifies the media asset (or aspect thereof). The challenge may identify why the challenge disputes the veracity of the media asset (or aspect thereof) and may provide replacement information that the challenger believes to be more correct than the disputed information in the media asset (or aspect thereof).

The challenge verification engine 142 may verify the veracity of a challenge submitted through the challenge submission engine 140. In some examples, the challenge verification engine 142 may verify the veracity of the challenge by verifying the veracity of the media asset (or aspect thereof) that is disputed in the challenge is, in fact, inaccurate. In some examples, the challenge verification engine 142 may verify the veracity of the challenge by verifying the veracity of the replacement information. In some examples, the challenge verification engine 142 may verify the veracity of a challenge based on an automated and/or controlled computerized analysis of the media asset (or aspect thereof). For instance, if the challenge disputes the authenticity of an image used in a news article, and contends that the image has been doctored, the challenge verification engine 142 may automatically run an image authentication algorithm. The challenge verification engine 142 can verify the veracity of the challenge based on the image authentication algorithm confirming that the image is doctored.

Similarly, the challenge verification engine 142 can use biometric analyses 155 for this purpose (e.g., voice print, facial recognition, iris recognition, and the like). In some examples, the challenge verification engine 142 may verify the veracity of a challenge by the results of a vote on the veracity of the challenge, the vote either open to the public or to a private group of fact checkers. If a quorum (e.g., over a predetermined threshold) of voters vote to verify the veracity of the challenge, the challenge verification engine 142 can verify the veracity of the challenge.

Different users may have different reputations, which may be created and managed by reputation management engine 145. Reputation may be stored as a score, which may be referred to as a reputation score, level, or metric. Historical reputation scores may be stored over time (e.g., in a table or graph or chart). Reputation may be calculated, for instance, based on how often the user's media assets are successfully challenged, how often the user successfully challenges media assets of others, and/or other factors. Reputation may be calculated based on the user's truthfulness (e.g., honesty, accuracy). Reputation may be calculated based on the user's rationality (e.g., logicality, circumspection). Reputation may be calculated based on the user's affective reputation (e.g., appropriateness, emotional self-control). Reputation may be calculated based on the user's community reputation (e.g. functions well in circumstances, gauge of audience). Reputation may be calculated based on the user's environment (e.g., audience truth-indifference, purpose of discourse). Reputation may be calculated based on the user's comprehensive factors (e.g. dedication to purpose, proper balance of other factors). In some examples, a user with a low reputation score may be required to put more funds forward as the as the potential compensation for a warranty than a user with a high reputation score.

In some examples, the reputation score is established or updated as part of a buyer/seller transaction where the seller (e.g., author and/or transmitter) and buyer (e.g., editor and/or publisher and/or recipient) assess the risk/vouch-safe/reputation of the transmitting party as to whether they want to receive/utilize the information element and this would be based on at least one of the following 3 attributes: 1. the existing reputation of the source(s) in the minds of the buyer; 2. the novelty/controversy/rationality/affective quality/truthfulness-risk/headline-fetching opportunity of the information element; 3 the cumulative warranties (representing stake) that the prior source(s) are warrantying that one or both of a) reputation or b) some falsifiable criteria wouldn't diminish below a certain threshold.

In some examples, the reputation score may be a system of weights to adjust the credibility and incentivization of the propagation of credible or not-credible information based on criteria including but not limited to the extent of propagation, magnitude/impact of the claims, measurable public attention given to the claims, likelihood of the claim, duration of claim, verifiability of claims, importance of claims for practical action suggested as a consequence, required cognitive or world-view reframing, variation from normal way of understanding things, portion of the prior criteria that are fulfilled over the duration of the claim comparable to a partially matured bond including any potential withdrawal terms, any other criteria discussed herein, or a combination thereof.

An information tracking engine 152 can track information as it goes through an information flow pipeline, from an information source 210 to an audience 270. In some examples, the information tracking engine 152 can tag a certain piece of information with an identifier code or number. In some examples, the information tracking engine 152 can tag an entity along the information flow pipeline (e.g., information source 210, content producer 220, publisher 230, secondary content producer 240, secondary publisher 250, challenger 260, and/or member of audience 270) with an identifier code or number. In some examples, the information tracking engine 152 can identify the same information as it appears in different media assets using a classifier, such as one utilizing one or more artificial intelligence (AI) algorithms, one or more trained machine learning (ML) models, one or more trained neural network (NNs), or a combination thereof. Movement of the information may be tracked based on dates of publication of media assets including the information, for instance. In some examples, flow of a piece of information can be tracked using the distributed ledger 160, for instance stored as a set of transactions identifying transfer of the code corresponding to the piece of information from a code corresponding to one entity along the information flow pipeline to a code corresponding to another entity along the information flow pipeline.

A compensation management engine 147 may manage disbursal of compensation for a warranty for a successfully challenged media asset (e.g., in response to successful verification of the challenge 280) to the challenger and/or one or more entities downstream of the media asset in the information flow pipeline. See, e.g., compensation 285 of FIG. 2C.

In some examples, the application layer 115 may include an API 117 that can trigger performance of an operation by the application layer 115 in response to being called by the interface layer 110, the infrastructure layer 120, the user device 105, the web server, another computing system 700 that is remote from the warranty system 100, or another device or system described herein. Any of the operations described herein as performed by the application layer 115 may be performed in response to a call of the API 117 by one of the devices or systems listed above.

The warranty system 100 may include one or more computing systems 700. In some examples, the interface layer 120 includes a first set of one or more computing systems 700. In some examples, the application layer 115 includes a second set of one or more computing systems 700. In some examples, the infrastructure layer 120 includes a third set of one or more computing systems 700. In some examples, one or more shared computing systems 700 are shared between the first set of one or more computing systems 700, the second set of one or more computing systems 700, and/or the third set of one or more computing systems 700. In some examples, one or more of the above-identified elements of the interface layer 120, the application layer 115, and/or the infrastructure layer 120 may be performed by a distributed architecture of computing systems 700.

FIG. 2A is a conceptual diagram 200A illustrating an information flow pipeline along which information flows from an information source to an audience. The information flow pipeline of FIG. 2A includes an information source 210, such as a person recording a first-hand video of an event. The information source 210 may include a reputation score 215 associated with the reputation management engine 145, for instance identifying the reputation of the person(s) that filmed and/or uploaded or otherwise circulated the video.

The information flow pipeline includes a content producer 220, such as a journalist, blogger, or social media user. The content producer 220 produces a media asset based on the information from the information source 210, such as an article, a photograph, a television segment, a radio segment, a social media post, or a combination thereof. The content producer 220 may also have a reputation score 225 associated with the reputation management engine 145.

The information flow pipeline includes a publisher 230 that accepts, edits, and/or publishes the media asset from the content producer 220. The publisher 230 may be, for example, a news agency, a television station, a radio station, or a social media platform. The publisher 230 may also have a reputation score 235 associated with the reputation management engine 145. The audience 270 (e.g., readers, viewers, consumers, and/or the general public) may access (e.g., read, view, and/or consume) the media asset from the publisher 230.

The information flow pipeline can include one or more secondary content producer(s) 240 and one or more secondary publisher(s) 250. Once the publisher 230 publishes the media asset, other, the one or more secondary content producer(s) 240 may produce secondary media assets that reference the media asset published by the publisher 230, and the one or more secondary publishers 250 may publish these secondary media assets. For instance, if the media asset published by the publisher 230 is a news article, the secondary media assets produced by the secondary content producer(s) 240 and published by the secondary publisher(s) 250 can be other articles or other types of media quoting, citing, or otherwise referencing the news article published by the publisher 230. The secondary content producer 240 may also have a reputation score 245 associated with the reputation management engine 145. The secondary publisher 250 may also have a reputation score 255 associated with the reputation management engine 145. The audience 270 may access the secondary media asset from the secondary publisher 250.

In some examples, a reputation of an entity (e.g., the reputation 215 of the information source 210, the reputation 225 of the content producer 220, the reputation 235 of the publisher 230, the reputation 245 of the secondary content producer 240, and the reputation of the secondary publisher 250) may be, or may have a component that is, independent of any specific media asset. In some examples, a reputation of an entity may be, or may have a component that is, associated with a specific media asset, and may for instance be based on the reputation(s) of source(s) for the content in that media asset, for instance based on an aggregation of these reputation(s). In an illustrative example, the reputation 225 of the content producer 220 with regard to a specific media asset may be based on the reputation 215 of the information source 210 that provided content for that media asset. In a second illustrative example, the reputation 255 of the secondary publisher 255 with regard to a specific media asset may be based on one or more of the reputation 215 of the information source 210, the reputation 225 of the content producer 220, the reputation 235 of the publisher 230, and/or the reputation 245 of the secondary content producer 240, each of which provided content for that media asset.

FIG. 2B is a conceptual diagram 200B illustrating a challenger issuing a challenge to the veracity of published media along the information flow pipeline. A challenger 260 is added to the information flow pipeline of FIG. 2A in FIG. 2B. Like the other entities in the information flow pipeline, the challenger may have a reputation score 265 associated with the reputation management engine 145. The challenger issues a challenge 280 (e.g., submitted through the challenge submission engine 140) that disputes the veracity of the media asset published by the publisher 230 (or an aspect thereof). In some cases, the audience 270 may see the challenge 180. However, even if the challenge 180 is accurate, the challenger 260 has a high reputation, and the publisher 230 issues a retraction or otherwise corrects the media asset, the audience 270 still might not see the challenge 280, for instance if the audience consumed the information through the secondary media asset published by the secondary publisher 250.

FIG. 2C is a conceptual diagram 200C illustrating the challenge from the challenger of FIG. 2B triggering compensation that flows downstream along the information flow pipeline for those who relied on the published media. Each entity in the information flow pipeline (other than the audience 270) now issues a warranty as to the veracity of its respective media content. For instance, the information source 210 has its warranty 217 on its information. The content producer 220 as a warranty 227 on the media asset produced based on that information. The publisher 230 has a warranty 237 based on the media asset published based on the produced media asset. The secondary content producer 240 has a warranty 247 on the secondary media content produced based on the publisher 230's published media content. The secondary publisher 250 has a warranty 257 on the secondary media content published based on the secondary content producer 240's produced secondary media content.

The challenger 260 (e.g., through a challenger user device 105) submits a challenge 280 referencing the content producer 220's warranty 227 as to the veracity of the media asset (or an aspect thereof) produced by content producer 220. The challenge 280 thus disputes the veracity of the media asset (or aspect thereof) produced by content producer 220, that was eventually published by the publisher 230. The warranty 227, like the other warranties of FIG. 2C, may be a smart contract. Once the warranty system 100 verifies the veracity of the challenge 280, warranty system 100 may determine that the condition in the warranty is met, and may perform the action identified in the warranty. The action, in this case, may be disbursal of compensation 285 (e.g., advertising revenue from the news article or a portion thereof) to the challenger 260 and/or to one or more downstream entities in the information flow pipeline (e.g., entities to the right of the content producer 220 in the information flow pipeline). This can ensure that users who access and/or relied on the media asset can be compensated for relying on inaccurate information promulgated by the content producer 220.

In some examples, an advertiser receive a portion of the compensation 285 (e.g., to be compensated for having their brand associated with information that turns out to be false or biased). In some examples, as discussed herein, one or more members of the audience 270 receive a portion of the compensation 285. In some examples, a secondary content producer 240 or secondary publisher 250 that still wants to publish secondary media content based on a successfully challenged media asset from publisher 230 (e.g., subject to a successful challenge 280) can have an increased burden placed (e.g., increased amount of compensation that they have to put up) if they still wish to publish the secondary media content. This may disincentivize forwarding and republication of concepts that are debunked, shown to be inaccurate, shown to be biased, and the like, while still allowing a secondary content producer 240 and/or secondary publisher 250 to publish the secondary media asset if they believe that the challenge 280 was incorrect or biased itself. In some examples, one or more members of the audience 270 can create rules to exclude any content below a given warrant/reputation score from view in a content viewer or content reader software application. In some examples, the stake (e.g., compensation 285) goes up with each new member of the audience 270 (e.g., incentivizing a content producer 220 or publisher 230 to correct inaccurate or biased statements quickly). In some examples, the warranties 217, 227, 237, 247, and/or 257 can be used as a form of journalistic malpractice insurance, with more salacious headlines (or other media assets) requiring greater stake (e.g., for the compensation 285).

In some examples, the challenger 260 can appear post-facto at any point in the conveyance pipeline. In some examples, each warranty can exist with or without a challenger 260 ever appearing to collect any part of the compensation 285. The compensation 285 can be an incentive (e.g., a bounty) that can act as a public invitation to the challenger 260. In some examples, the cumulative warranties (e.g., warranties 217, 227, 237, 247, and/or 257) can be passed along as much as a vouch-safes to the audience 270 (vis a vis the content's trustworthiness and each source's reputation) throughout its chain of custody in editing/publishing.

In some examples, the audience 270 can affect pricing of a warranty, for instance based on demographic criteria. For example, the larger the size of the audience 270, the more advertising is worth and therefore the more an entity along the information flow pipeline may have to put upfront for the warranty. In another example the measures and monetizations of attention expressed might be expressed through mechanisms such as Basic Attention Tokens. In some examples, a member of the audience 270 can, through an interface in the interface layer 110 of the warranty system 100, bet their own funds or reputation that an idea (e.g., an aspect of a media asset) will prove to be false. Such a user may receive an increased amount of the compensation 285 if the idea eventually proves to be false, and their contribution can be used as part of a reward to a challenger to help incentivize the challenger 260 to begin investigating. In another example the warrant may be dynamic over time wherein users may be required to stake greater or less financial interest over the duration of the warranty due to greater or lesser risk according to there being greater or lesser risk in a claim being in error, in turn the payoff amounts may adjust as well. Additional smart contract structures may also be implemented. The warranty system 100 may employ various methods to establish relevant reputation data for content producers, publishers, and information consumers including polling on specific questions, data on viewpoint deflection, engagement or disengagement, expressed sentiment data, social media interaction, forum or comment area surveillance, and so forth.

FIG. 3 is a block diagram illustrating a distributed ledger configured to store smart contracts and provide for execution of the smart contracts. Three blocks—Block A 305, Block B 335, and Block C 365—of the blockchain ledger 300 are illustrated in FIG. 3.

Each block includes a block header 310/340/370 and a list of one or more payloads 330/360/390. The block header 310 includes a hash of the block header of the previous block 315/345/375, which may alternately be replaced or supplemented by a hash of the entire previous block. For instance, the header 370 of block C 365 includes a hash 375 of the header 340 of block B 335. The header 340 of block B 335 likewise includes a hash 345 of the header 310 of block A 305. The header 310 of block A 305 likewise includes a hash 315 of a header (not pictured) of previous block (not pictured) that is before block A 305 in the blockchain 300. Including the hash of the previous block's header secures the blockchain ledger 300 by preventing modification of any block of the blockchain 300 after the block has been entered into the blockchain 300, as any change to a particular block would cause that block header's hash in the next block to be incorrect. Further, modification of that block header's hash in the next block would make the next block's header's hash in the block after the next block incorrect, and so forth.

Each block's block header 310/340/370 also includes a Merkle root 320/350/380, which is generated based on hashes of the payload(s) listed in the list of payload(s) 330/360/390 for that block. Any attempt to modify a payload after the block has been entered would change the Merkle root 320/350/380, which would change the hash 315/345/375 of the block header 310/340/370, again allowing all nodes to see if any block has been tampered with. Each payload of each block may include one or more transactions, one or more smart contracts, other content, or combinations thereof.

Each block's block header 310/340/370 may also include various elements of metadata, such as a version number for the blockchain ledger platform, a version number for the block itself that identifies how many nonces have been tried, a timestamp for verification of each payload, a timestamp for generation of the block, a difficulty target value (e.g., adjusting difficulty of mining), a nonce value (e.g., a randomized value used to further randomize the hashes), or a combination thereof.

Each block 305/335/365 of the blockchain 300 also includes a list of one or more payload(s) 330/360/390. If the payload(s) 330/360/390 include a smart contract, the block may include the code of the smart contract. If the payload(s) 330/360/390 include a smart contract, the block may include a hash of the code of the smart contract, while the code of the smart contract is stored elsewhere (e.g., the cloud storage system 175).

While FIG. 3 only illustrates three blocks 305/335/365 of the blockchain 300, it should be understood that any blockchain discussed herein may be longer or shorter in that it may have more or fewer than three blocks.

In one illustrative example, a first computing device can store a blockchain ledger including a plurality of blocks. Each of a plurality of computing devices (e.g., in a distributed architecture) also stores a copy of the blockchain ledger. The first computing device can receive a message identifying an intended payload element (e.g., transaction and/or smart contract). For example, the intended payload element may be a smart contract related to one of the warranties described herein. The first computing device can verify that the intended payload element is valid. For instance, for a transaction, the first computing device can verify whether the transferor has a sufficient quantity of funds (or of whatever asset is being transferred in the transaction) for the transaction to take place. For a smart contract, the first computing device can verify that the smart contract refers to valid accounts that include sufficient funds (or other assets) to execute the smart contract (e.g., to transfer payment in amount(s) associated with the compensation 285). The first computing device can generate a hash of a most recent block of the blockchain ledger. The first computing device can generate a new block header for a new block. The new block header can include at least the hash of the most recent block of the blockchain ledger. The first computing device can generate the new block, the new block including at least the intended payload element and the new block header. The first computing device can append the new block to the plurality of blocks of the blockchain ledger in response to verifying the intended payload element. The first computing device can transmit the new block to the plurality of computing devices that each store the blockchain ledger in response to verifying the intended payload element. Each of the plurality of computing devices also appends the new block to their respective copy of the blockchain ledger.

In another illustrative example, a first computing device can store a blockchain ledger including a plurality of blocks. Each of a plurality of computing devices (e.g., in a distributed architecture) also stores a copy of the blockchain ledger. The first computing device can receive a UI input identifying an intended payload element (e.g., transaction and/or smart contract). The first computing device can generate a message identifying the intended payload element. The first computing device can retrieve a private key associated with an account corresponding to the first computing device. The first computing device can modify the message by encrypting at least a portion of the message with the private key. The first computing device can transmit the message to the plurality of computing devices other than the first computing device. A second computing device of the plurality of computing devices verifies that the intended payload element is valid, for instance as described in the previous paragraph. The first computing device receives a new block from the second computing device. The new block identifies and/or includes the intended payload element (e.g., in its payload). The first computing device appends the new block to the plurality of blocks of the blockchain ledger at the first computing device.

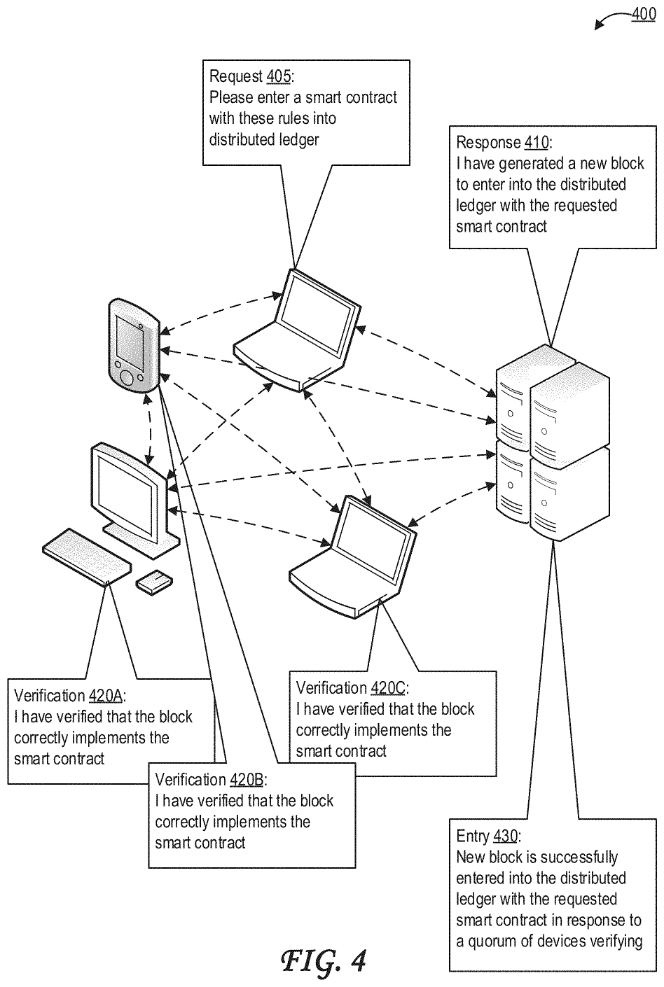

FIG. 4 is a conceptual diagram 400 illustrating a distributed computing architecture for initiating a smart contract using a distributed ledger. The distributed computing architecture includes multiple computing systems 700 (referred to further as computers) that store and modify the distributed ledger. A first computer submits a request 405 requesting entry of a smart contract with particular rules into distributed ledger. A second computer submits a response 410 indicating that the second computer has generated a new block to enter into the distributed ledger with the requested smart contract. Third, fourth, and fifth computers submit verification 420A-420C indicating that they have verified that the block correctly implements the smart contract. The second computer submits and entry confirmation indicating that the new block is successfully entered into the distributed ledger with the requested smart contract in response to a quorum of devices verifying.

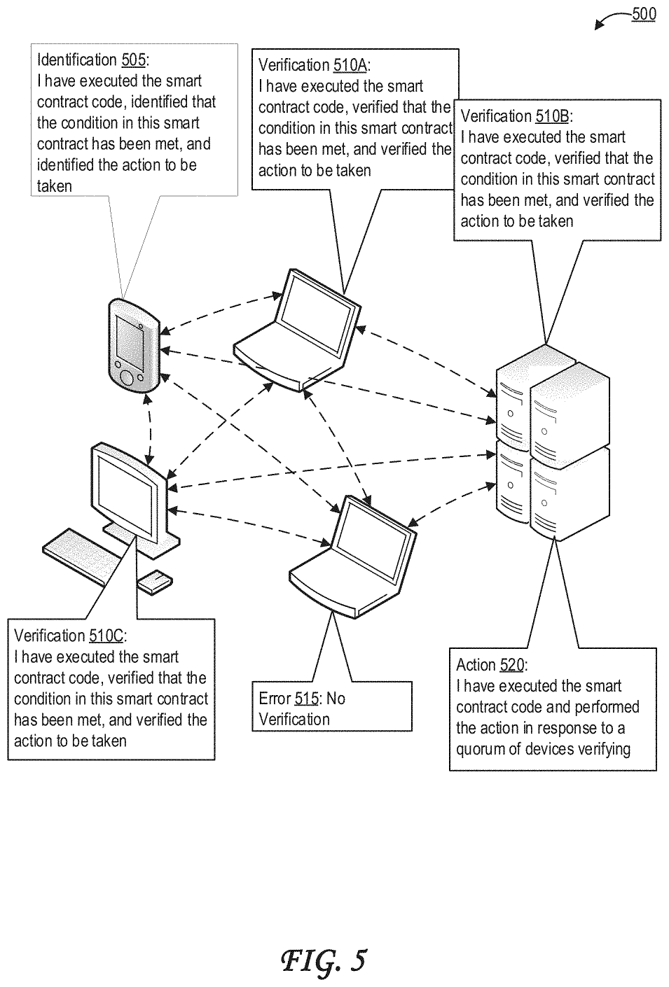

FIG. 5 is a conceptual diagram 500 illustrating a distributed computing architecture for initiating a smart contract using a distributed ledger. The distributed computing architecture includes multiple computing systems 700 (referred to further as computers) that store and modify the distributed ledger. A first computer submits an identification 505 that the first computer has executed the smart contract code, identified that the condition in this smart contract has been met, and identified the action to be taken. Second, third, and fourth computers submit verifications 510A-510C that identify that the second, third, and fourth computers have executed the smart contract code, verified that the condition in this smart contract has been met, and verified the action to be taken. A fifth computer indicates an error 515 with no verification. The third computer indicates an action 520, indicating that the third computer has executed the smart contract code and performed the action in response to a quorum of devices verifying (e.g. the verifications 510A-510C).

FIG. 6 is a conceptual diagram 600 illustrating a directed acyclic graph (DAG) ledger configured to store smart contracts and provide for execution of the smart contracts. While FIG. 3 discusses use of a blockchain ledger, it should be understood that a non-linear ledger structure, such as the directed acyclic graph (DAG) ledger structure of FIG. 6, may be used instead of a blockchain ledger discussed herein. That is, the term “distributed ledger” as used herein should be understood to refer to at least one of a blockchain ledger (as in FIG. 3), a DAG ledger (as in FIG. 6), or a combination thereof. In a DAG ledger, each block header includes the hashes of block headers of a predetermined number of other “parent” blocks in the DAG ledger selected either at random or in some other non-linear manner, rather than the hash of a single previous block in the blockchain. Each block header may alternately or additionally include hashes of the entire parent blocks instead of hashes of just the headers of the parent blocks. Where each block header includes multiple hashes corresponding to different parent blocks or their headers, these hashes can be combined together into a Merkle root

For example, in the DAG ledger of FIG. 6, the predetermined number is two, at least after the first two blocks are generated. In the web DAG ledger of FIG. 6, the parent blocks are indicated using arrows. Block 610 includes hashes of the block headers of parent blocks 620 and 650. Block 620 includes hashes of the block headers of parent blocks 640 and 660. Block 630 includes hashes of the block headers of parent blocks 620 and 660. Block 640 includes hashes of the block headers of parent blocks 610 and 630. Block 650 includes hashes of the block headers of parent blocks 610 and 620. Block 660 includes hashes of the block headers of parent blocks 610 and 650. The resulting structure is a directed acyclic graph (DAG) of blocks, where each vertex block includes a hash of its parent vertex block(s), rather than a linear stream of blocks as in a blockchain. A DAG ledger may sometimes be referred to as a “web,” a “tangle,” or a “hashgraph.”

In some cases, the number of parent blocks in a DAG ledger is not strictly predetermined, but there is a predetermined minimum number of blocks, such as a two-parent minimum or a one-parent minimum, meaning that each block has at least the predetermined minimum number of parent blocks. In some cases, each block in a DAG ledger may only identify only a single transaction rather than multiple transactions, and may therefore forego a Merkle root and/or replace it with a hash of the single transaction. In other implementations, each block may identify multiple transactions associated with a predetermined time period as discussed herein.

Potential benefits of distributed DAG ledgers over blockchain ledgers may include parallelized validation, which results in higher throughput.

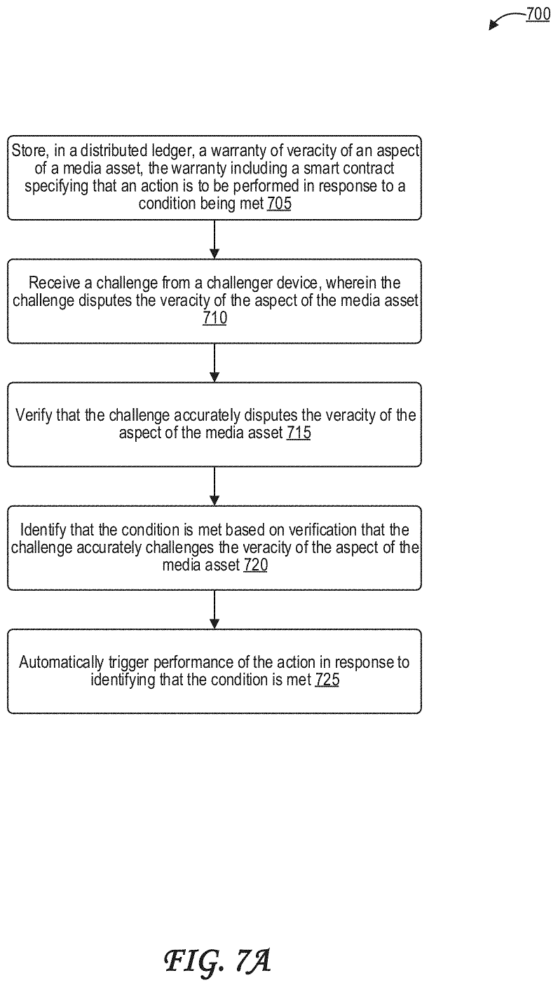

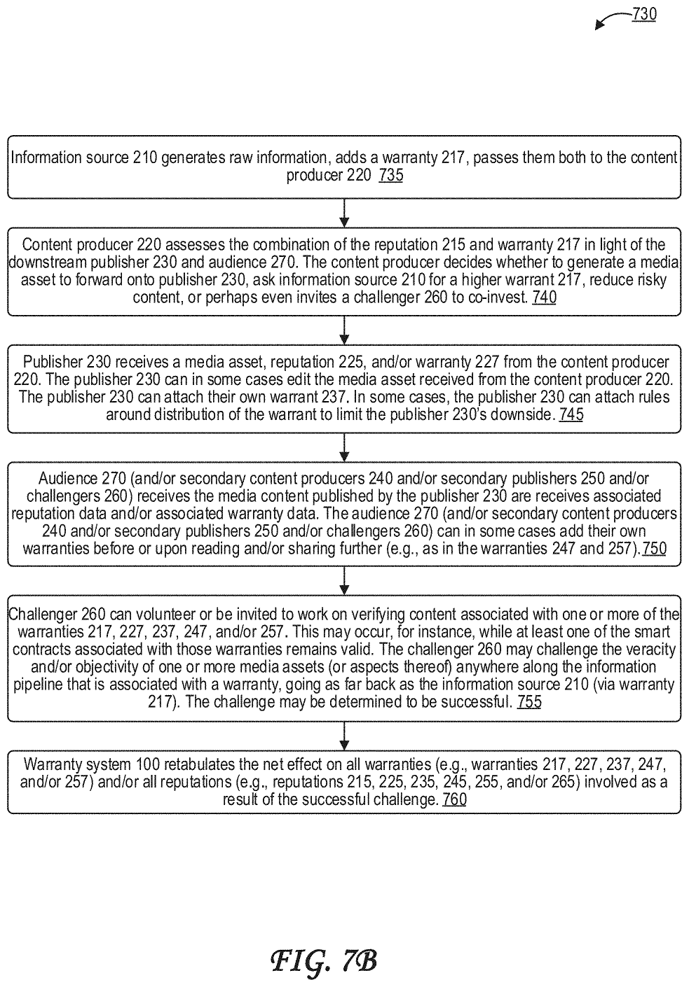

FIG. 7A is a flow diagram illustrating example operations 700 for automated media veracity challenge verification and enforcement. The operations 700 are performed by a media asset management system, which may include the warranty system 100, one or more devices associated with various entities identified in FIG. 2A-2C, one or more of the systems illustrated in FIG. 4, one or more of the systems illustrated in FIG. 5, the media asset management system of FIG. 7B, a computing system 800, another device or system discussed herein, one or more components or subsystems of any of the previously-listed systems, or a combination thereof.

At operation 705, the media asset management system stores, in a distributed ledger, a warranty of veracity of an aspect of a media asset. The warranty includes a smart contract specifying that an action is to be performed in response to a condition being met. The media asset management system may receive the media asset from a user device 105 through the interface layer 110. Examples of the media asset include any media assets discussed with respect to FIGS. 1, 2A-2C, 3, 4, 5, 6, and 7B. Examples of the warranty includes the warranty 217, the warranty 227, the warranty 237, the warranty 247, the warranty 257, and the warranty 267. Examples of the smart contract include smart contracts discussed with respect to the smart contract rules determination engine 135, smart contracts discussed with respect to the smart contract rules status detection engine 137, the smart contracts 165, smart contracts stored in the payload 330, smart contracts stored in the payload 360, smart contracts stored in the payload 390, the smart contracts of FIG. 4, the smart contracts of FIG. 5, any smart contracts stored in the DAG ledger of FIG. 6, the smart contracts of FIG. 7B, or a combination thereof.

At operation 710, the media asset management system receives a challenge from a challenger device. The challenge disputes the veracity of the aspect of the media asset. Examples of the challenger device includes the user device 105, the challenger 260, the audience 270, the content producer 220, the publisher 230, the secondary content producer 240, the secondary publisher 250, the computing system 800, or a combination thereof. Examples of the challenge include challenges submitted using the challenge submission engine 140, challenges verified using the challenge verification engine 142, the challenge 280, challenges by the challenger 260 or any other type of challenger device listed above, or a combination thereof.

In some examples, the media asset includes a written assertion, and the challenge challenges the veracity of the aspect of the media asset at least by challenging the veracity of the written assertion. For instance, the veracity of the written assertion can be challenged by challenging the truth of the written assertion, challenging whether the written assertion is an opinion rather than truth, challenging whether the written assertion misquotes a person, whether the written assertion cites misleading evidence, whether the written assertion includes one or more logical fallacies, whether the written assertion is tainted by cognitive bias, whether the written assertion is “fake news,” or combinations thereof. In some examples, the media asset includes an image, and the challenge challenges the veracity of the aspect of the media asset at least by challenging the veracity of the image. In some examples, the media asset includes a video, and the challenge challenges the veracity of the aspect of the media asset at least by challenging the veracity of the video. In some examples, the media asset includes an audio recording, and the challenge challenges the veracity of the aspect of the media asset at least by challenging the veracity of the audio recording. For instance, challenging the veracity of an image, video, or audio recording can challenge whether the image, video, or audio recording has been manipulated using image, video, or audio processing. For instance, manipulation of the media asset can be performed to distort the truth of a situation depicted or represented in the image, video, or audio recording. Challenging the veracity of a media asset can also include challenging whether the media asset is used in a misleading way, for instance whether an image, video, or audio clip in an article truly depicts or represents what a caption or article expressly says, or more subtly suggests, that it depicts or represents. Challenging the veracity of a media asset can also include verification of blockchain data integrity, verification of data transfer integrity, or a combination thereof.

Logical fallacies that can be assessed in the challenge to the veracity of the media asset can include, for instance, an ad hominem fallacy, a strawman argument, an appeal to ignorance, a false dilemma or false dichotomy, a slippery slope fallacy, a circular argument, a hasty or faulty generalization, a red herring fallacy, an appeal to hypocrisy, a causal fallacy, a fallacy of sunk costs, an appeal to authority, an equivocation, an appeal to pity, a bandwagon fallacy, a post hoc fallacy, a weak analogy, an ad populum fallacy, a to quoque fallacy, an improper or weak premise, a questionable cause, a relevance fallacy, an omission of relevant information, a formal fallacy as an error in an argument's form, a propositional fallacy that concerns compound propositions, a quantification fallacy where quantifiers of premises contradict quantifiers of a conclusion, a syllogistic fallacy concerning an error in a syllogism, or a combination thereof.

At operation 715, the media asset management system verifies that the challenge accurately disputes the veracity of the aspect of the media asset. At operation 720, the media asset management system identifies that the condition is met based on verification that the challenge accurately challenges the veracity of the aspect of the media asset. Examples of operation 715 and/or operation 720 include the operations of the challenge verification engine 142, the systems of FIG. 4, the systems of FIG. 5, or a combination thereof.

Verification as to the validity of the challenge can include verification of any of the aspects of veracity of the media asset that are challenged at operation 710, including any of the aspects that are listed above or otherwise could be assessed as degradations in believability or persuasive quality of the media asset, such as poor reasoning, poor tone, poor context, poor citations, and the like. Verification as to the validity of the challenge can include verification of the truth of a media asset and/or of the challenge, verification of whether the media asset and/or the challenge references an opinion rather than truth, verification of whether the media asset and/or the challenge misquotes a person, verification of whether the media asset and/or the challenge cites misleading evidence, verification of whether the media asset and/or the challenge includes one or more logical fallacies, verification of whether the media asset and/or the challenge is tainted by cognitive bias, verification of whether the media asset and/or the challenge is “fake news,” verification of whether the media asset and/or the challenge is misleading, verification of whether the media asset and/or the challenge includes media that is manipulated using media processing, verification of whether the media asset and/or the challenge omits relevant information, verification of blockchain data integrity, verification of data transfer integrity, or a combination thereof.

At operation 725, the media asset management system automatically triggers performance of the action in response to identifying that the condition is met. In some examples, the media asset management system automatically triggers performance of the action by automatically performing the action.

In some examples, performance of the action includes payment of compensation from an account associated with publication of the media asset to one or more recipient accounts. Examples of the compensation include the compensation 285, compensation managed by the compensation management engine 147, or a combination thereof. For instance, in some examples, performance of the action includes payment of compensation from an account associated with publication of the media asset to one or more accounts associated with the challenger device (e.g., compensation 285 from the content producer 220 to the challenger 260 in the context of FIG. 2C). In some examples, performance of the action includes payment of compensation from an account associated with publication of the media asset to one or more accounts associated with a user that has accessed the media asset (e.g., compensation 285 from the content producer 220 to the publisher 230, the secondary content producer 240, the secondary publisher 250, the challenger 260, and/or the audience 270 in the context of FIG. 2C). In some examples, performance of the action includes payment of compensation from an account associated with publication of the media asset to one or more accounts associated with a user that has relied on the veracity of the aspect of the media asset (e.g., compensation 285 from the content producer 220 to the publisher 230, the secondary content producer 240, the secondary publisher 250, the challenger 260, and/or the audience 270 in the context of FIG. 2C).

In some examples, performance of the action includes modifying one or more reputation metrics. Examples of the reputation metrics include reputation metrics managed using the reputation management engine 145, the reputation 215, the reputation 225, the reputation 235, the reputation 245, the reputation 255, the reputation 265, or a combination thereof. The one or more reputation metrics can correspond to an account associated with the challenger and/or to an account associated with publication of the media asset. For instance, in some examples, performance of the action includes modifying (e.g., decreasing) a reputation metric corresponding to an account associated with publication of the media asset (e.g., the content producer 220, the publisher 230, the secondary content producer 240, and/or the secondary publisher 250 in the context of FIG. 2C) from a first value to a second value. In some examples, performance of the action includes modifying (e.g., increasing) a reputation metric corresponding to an account associated with the challenger device (e.g., the challenger 260 in the context of FIG. 2C) from a first value to a second value. In some cases, the numeric amount of the compensation paid out in the action can be based on the reputation metric of the account associated with publication of the media asset, prior to the modification or after the modification. For instance, in some examples, a lower reputation metric corresponds to a higher amount of the compensation, while a higher reputation metric corresponds to a lower amount of the compensation.

FIG. 7B is a flow diagram illustrating example operations 730 for automated media veracity challenge verification and enforcement. The operations 700 are performed by a media asset management system, which may include the warranty system 100, one or more devices associated with various entities identified in FIG. 2A-2C, one or more of the systems illustrated in FIG. 4, one or more of the systems illustrated in FIG. 5, the media asset management system of FIG. 7B, a computing system 800, and/or another device or system discussed herein, one or more components or subsystems of any of the previously-listed systems, or a combination thereof.

At operation 735, an information source 210 (using an associated user device 105) generates raw information (e.g., a premise, media content, an idea, etc.), adds a warranty 217, passes them both to the content producer 220 (e.g., via the warranty system 100).

At operation 740, the content producer 220 assesses the combination of the reputation 215 and warranty 217 in light of the downstream publisher 230 and audience 270. The content producer decides whether to generate a media asset to forward onto publisher 230, ask information source 210 for a higher warrant 217, reduce risky content, or perhaps even invites a challenger 260 to co-invest.

At operation 745, the publisher 230 receives a media asset, reputation 225, and/or warranty 227 from the content producer 220, and may in some examples also have access to the raw information from the information source 210, the reputation 215, and/or the warranty 217. The publisher 230 can in some cases edit the media asset received from the content producer 220 (e.g., with the downstream audience 270 in mind). The publisher 230 can attach their own warrant 237. In some cases, the publisher 230 can attach rules around distribution of the warrant to limit the publisher 230's downside (e.g. the warranty 237 is only visible to and/or usable by the first 1000 viewers in the audience 270).

At operation 750, the audience 270 (and/or secondary content producers 240 and/or secondary publishers 250 and/or challengers 260) receives the media content published by the publisher 230 are receives associated reputation data (e.g., the reputations 215, 225, and/or 235) and/or associated warranty data (e.g., the warranties 217, 227, and/or 237). The audience 270 (and/or secondary content producers 240 and/or secondary publishers 250 and/or challengers 260) can in some cases add their own warranties before or upon reading and/or sharing further (e.g., as in the warranties 247 and 257).

At operation 755, a challenger 260 (e.g., researcher, analyst) can volunteer or be invited to work on verifying content associated with one or more of the warranties 217, 227, 237, 247, and/or 257. This may occur, for instance, while at least one of the smart contracts associated with those warranties remains valid (e.g., some smart contracts may be timed so that the condition may only be met within a certain time of creation of the smart contract). The challenger 260 may challenge the veracity and/or objectivity of one or more media assets (or aspects thereof) anywhere along the information pipeline that is associated with a warranty, going as far back as the information source 210 (via warranty 217). The challenge may be determined to be successful as discussed herein.

At operation, 760, the warranty system 100 retabulates the net effect on all warranties (e.g., warranties 217, 227, 237, 247, and/or 257) and/or all reputations (e.g., reputations 215, 225, 235, 245, 255, and/or 265) involved as a result of the successful challenge. For instance, if a challenger 260 successfully challenges the warranty 227 of the content producer 220, the reputation 225 of the content producer 220 may fall, and future warranties by the content producer 220 may be more costly for the content producer 220 (e.g., since the content producer 220's content is riskier according to the warranty system 100). Meanwhile, the reputation 265 of the challenger 260 may increase, and future warranties by the challenger 260 may reduce in cost for the challenger 260 (e.g., since the challenger 260's content is more trusted according to the warranty system 100).

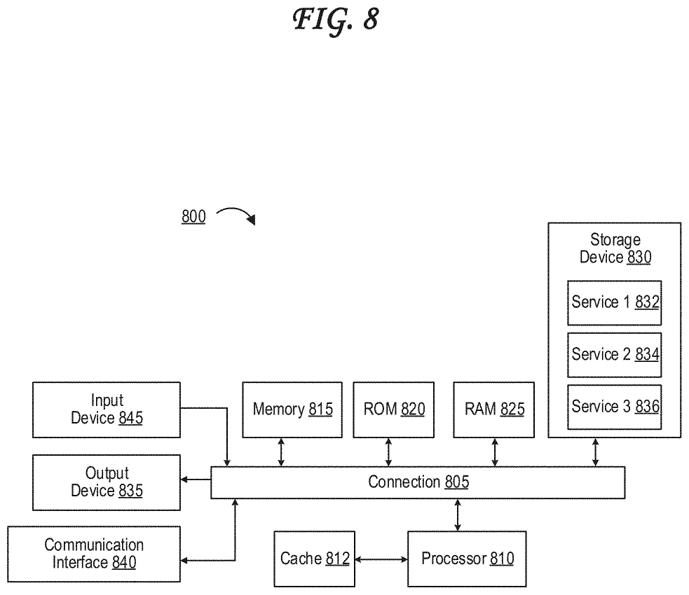

FIG. 8 is a diagram illustrating an example of a system for implementing certain aspects of the present technology. In particular, FIG. 8 illustrates an example of computing system 800, which can be for example any computing device or computing system making up the an internal computing system, a remote computing system, or any combination thereof. The components of the system are in communication with each other using connection 805. Connection 805 can be a physical connection using a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method of automated media content challenge verification and enforcement, the method comprising:
storing, in a distributed ledger, a warranty of veracity of an aspect of a media asset, the warranty including a smart contract specifying that an action is to be performed in response to a condition being met;
receiving a challenge from a challenger device, wherein the challenge disputes the veracity of the aspect of the media asset;
verifying that the challenge accurately disputes the veracity of the aspect of the media asset;
identifying that the condition is met based on verification that the challenge accurately challenges the veracity of the aspect of the media asset; and
automatically triggering performance of the action in response to identifying that the condition is met.

2. The method of claim 1, wherein the media asset includes a written assertion, wherein the challenge challenges the veracity of the aspect of the media asset at least by challenging the veracity of the written assertion.

3. The method of claim 1, wherein the media asset includes an image, wherein the challenge challenges the veracity of the aspect of the media asset at least by challenging the veracity of the image.

4. The method of claim 1, wherein the media asset includes a video, wherein the challenge challenges the veracity of the aspect of the media asset at least by challenging the veracity of the video.

5. The method of claim 1, wherein the media asset includes an audio recording, wherein the challenge challenges the veracity of the aspect of the media asset at least by challenging the veracity of the audio recording.

6. The method of claim 1, wherein automatically triggering performance of the action includes automatically performing the action.

7. The method of claim 1, wherein performance of the action includes payment of compensation from an account associated with publication of the media asset to one or more accounts associated with the challenger device.

8. The method of claim 1, wherein performance of the action includes payment of compensation from an account associated with publication of the media asset to one or more accounts associated with a user that has accessed the media asset.

9. The method of claim 1, wherein performance of the action includes payment of compensation from an account associated with publication of the media asset to one or more accounts associated with a user that has relied on the veracity of the aspect of the media asset.

10. The method of claim 1, wherein performance of the action includes decreasing a reputation metric corresponding to an account associated with publication of the media asset from a first value to a second value.

11. The method of claim 1, wherein performance of the action includes increasing a reputation metric corresponding to an account associated with the challenger device from a first value to a second value.

12. A system for automated media content challenge verification and enforcement, the system comprising:
a memory storing instructions; and
one or more processors that execute the instructions, wherein execution of the instructions by the one or more processors causes the one or more processors to:
store, in a distributed ledger, a warranty of veracity of an aspect of a media asset, the warranty including a smart contract specifying that an action is to be performed in response to a condition being met;
receive a challenge from a challenger device, wherein the challenge disputes the veracity of the aspect of the media asset;
verify that the challenge accurately disputes the veracity of the aspect of the media asset;
identify that the condition is met based on verification that the challenge accurately challenges the veracity of the aspect of the media asset; and
automatically trigger performance of the action in response to identifying that the condition is met.

13. The system of claim 12, wherein the media asset includes a written assertion, wherein the challenge challenges the veracity of the aspect of the media asset at least by challenging the veracity of the written assertion.

14. The system of claim 12, wherein the media asset includes an image, wherein the challenge challenges the veracity of the aspect of the media asset at least by challenging the veracity of the image.

15. The system of claim 12, wherein the media asset includes a video, wherein the challenge challenges the veracity of the aspect of the media asset at least by challenging the veracity of the video.

16. The system of claim 12, wherein the media asset includes an audio recording, wherein the challenge challenges the veracity of the aspect of the media asset at least by challenging the veracity of the audio recording.

17. The system of claim 12, wherein automatically triggering performance of the action includes automatically performing the action.

18. The system of claim 12, wherein performance of the action includes payment of compensation from an account associated with publication of the media asset to one or more recipient accounts.

19. The system of claim 12, wherein performance of the action includes modifying one or more reputation metrics, the one or more reputation metrics corresponding to at least one of an account associated with the challenger device and an account associated with publication of the media asset.

20. A non-transitory computer readable storage medium having embodied thereon a program, wherein the program is executable by a processor to perform a method of automated media content challenge verification and enforcement, the method comprising:
storing, in a distributed ledger, a warranty of veracity of an aspect of a media asset, the warranty including a smart contract specifying that an action is to be performed in response to a condition being met;
receiving a challenge from a challenger device, wherein the challenge disputes the veracity of the aspect of the media asset;
verifying that the challenge accurately disputes the veracity of the aspect of the media asset;
identifying that the condition is met based on verification that the challenge accurately challenges the veracity of the aspect of the media asset; and
automatically triggering performance of the action in response to identifying that the condition is met.
